(19) United States
(12) Patent Application Publication
(10) Pub. No.: US 2007/0187969 A1
(43) Pub. Date: Aug. 16, 2007

(54) Cargo Storage Compartment and Access Thereto

(75) Inventors: James D. DOWD, Farmington Hills, MI (US); Marc A. HAYES, Plymouth, MI (US); Joseph McKEEVER, Troy, MI (US)

Correspondence Address: GROSSMAN, TUCKER, PERREAULT & PFLEGER, PLLC, 55 SOUTH COMMERICAL STREET, MANCHESTER, NH, 03101, US

(73) Assignee: COLLINS & AIKMAN PRODUCTS CO., Southfield, MI (US)

(21) Appl. No.: 11/464,056

(22) Filed: Aug. 11, 2006

Related U.S. Application Data
(60) Provisional application No. 60/773,836, filed on Feb. 16, 2006.

(51) Int. Cl. B60R 7/00

(52) U.S. Cl. 296/37.1

(57) ABSTRACT

An expandable/collapsible apparatus is provided for storing items within vehicle compartments that may be manipulated into an operative position or into a closed position. The apparatus may include a plurality of panels that are pivotally attached to one another so that the apparatus is movable between a closed position beneath, e.g., an upper panel or roof portion of a vehicle and an open position expanded for receiving items for storage. A spring loaded latch may be provided for securing the apparatus in either a collapsed or expanded (drop-down) position. Access to the apparatus may be through the trunk or rear cargo area of a vehicle or through a door formed in the package shelf of a vehicle.

### CROSS REFERENCE TO RELATED APPLICATIONS

This application claims the benefit of U.S. Provisional Application No. 60/773,836, filed Feb. 16, 2006.

### FIELD OF THE INVENTION

The present invention relates generally to cargo management apparatus for use within vehicles, and more particularly, to an expandable/collapsible and/or drop-down compartment and access thereto.

### BACKGROUND OF THE INVENTION

Motor vehicles are typically provided with a cargo storage compartment of some type. For example, sedan-style automobiles are conventionally equipped with a trunk. Sport/utility, station wagon, crossover vehicles and mini-vans, in which there are two or more rows of seating, are conventionally provided with a cargo storage area behind the last row of seating. In many cases, these rows of seats are removable so that more cargo space may be made available.

Items carried within vehicle cargo storage areas are often free to move about during vehicle operation, which may be undesirable. Cargo netting may be used to restrain items from movement within vehicle cargo storage compartments. While such netting may adequately restrain items from movement, cargo netting may require the use of two hands to hold the cargo netting back while placing items therewithin, which may be cumbersome.

Various devices are known for dividing vehicle storage compartments to prevent movement of items stored therein. For example, U.S. Pat. No. 6,027,155 to Wisniewski, et al. describes a storage system for a vehicle cargo compartment that includes a cover that is removably attached to the floor of the cargo compartment and that is configured to rotate between open and closed positions. U.S. Pat. No. 5,669,537 to Saleem, et al. describes a storage unit that extends between, and connects to, vehicle panels of a vehicle storage area. U.S. Pat. No. 5,501,384 to Wisniewski, et al. describes a storage system for a vehicle that includes a molded bin and a cover pivotally secured to the bin.

Unfortunately, these devices are somewhat complex and bulky and are not adapted to be compactly stored themselves within the cargo storage area of the vehicle. Moreover, in automotive vehicles such as sport/utility vehicles and mini-vans, with all the seats in place, cargo storage space maybe somewhat limited. Accordingly, a need exists for a cargo storage device that can securely retain items within a cargo storage area during operation of a vehicle and that can be easily folded up or collapsed in an out-of-the-way location when not needed. In addition, it may be preferred that one does not have to remove the storage apparatus from the cargo storage area when not in use. In addition, a need exists to maximize the efficiency and utilization of existing cargo storage space without intruding on passenger space.

### SUMMARY OF THE INVENTION

The present invention is directed at a collapsible/expandable cargo storage apparatus for use within vehicle compartments (e.g., automobile trunks, mini-van and SUV cargo areas, and the like). According to an exemplary embodiment of the present invention, a storage apparatus may include a plurality of panels pivotally attached to one another such that, in a first, expanded, position, the panels are in an adjacent spaced-apart relationship and form one or more storage compartments. In a second collapsed position, the panels may articulate and at least partially overlie one another for storage. The apparatus may be disposed adjacent the underside of a vehicle compartment roof (or the undersurface of the upper back panel of a luggage compartment or other substantially horizontal panel in a vehicle). The apparatus may be configured to form a single compartment which may optionally be fitted with a sliding drawer, or may include front and rear hinged panels capable of latching to the other panels. In another embodiment, the apparatus may have a configuration that forms a plurality of storage compartments when expanded. A spring-loaded latch may be included to secure the apparatus in the collapsed position against the roof or undersurface. Thus, in the open position, the apparatus defines one or more storage compartments for receiving items therein. In the collapsed position, the apparatus may allow for normal use of the cargo space.

According to embodiments of the present invention, the apparatus may be disposed at least partially beneath a vehicle roof or underside of the top of a storage compartment such that the apparatus may be substantially flush with the undersurface when the apparatus is in a collapsed position. Additionally, the storage space formed by the expanded apparatus may be accessible from within the occupants' compartment as, for instance, a waste container or toy storage area.

According to another embodiment of the present invention, access to such storage devices may be possible through an opening or door formed in the rear package shelf. This may allow access to the apparatus of the present invention, as well as to other areas of the trunk of a vehicle from within the passenger space.

### BRIEF DESCRIPTION OF THE DRAWINGS

These and other objects, features and advantages of the present invention will become apparent to those skilled in the art upon reference to the following written description and accompanying drawings in which:

FIGS. 1A and 1B are perspective views of an exemplary expandable/collapsible storage apparatus for storing items within a vehicle compartment.

FIG. 2 is a perspective view of an exemplary expandable/collapsible storage apparatus in expanded condition.

FIGS. 3A and 3B are front views of the exemplary expandable/collapsible storage apparatus of FIG. 2 in an expanded and in a collapsed or folded condition, respectively.

FIG. 4 is an exploded view of the exemplary expandable/collapsible storage apparatus of FIG. 2 for storing items within a vehicle compartment.

FIGS. 5A-5G are schematic views of alternate configurations of an exemplary storage apparatus.

FIG. 6 is a schematic view of a vehicle including a door in the package shelf for access to the storage apparatus of the present invention.

FIG. 7 is a perspective view of the door of FIG. 6 in an open condition to allow access to the storage apparatus of the present invention.

### DETAILED DESCRIPTION OF THE INVENTION

The present invention is described more fully hereinafter with reference to the accompanying drawings, in which preferred embodiments of the invention are shown. This invention, may, however, be embodied in many different forms and should not be construed as limited to the embodiments set forth herein.

In the drawings, the thickness of lines, layers and regions may be exaggerated for clarity. It will be understood that when an element such as a layer, region, substrate, or panel is referred to as being “on” another element, it can be directly on the other element or intervening elements may also be present. In contrast, when an element is referred to as being “directly on” another element, there are no intervening elements present. It will be understood that when an element is referred to as being “connected” or “attached” to another element, it can be directly connected or attached to the other element or intervening elements may also be present. In contrast, when an element is referred to as being “directly connected” or “directly attached” to another element, there are no intervening elements present. The terms “upwardly”, “downwardly”, “vertical”, “horizontal” and the like are used herein for the purpose of explanation only.

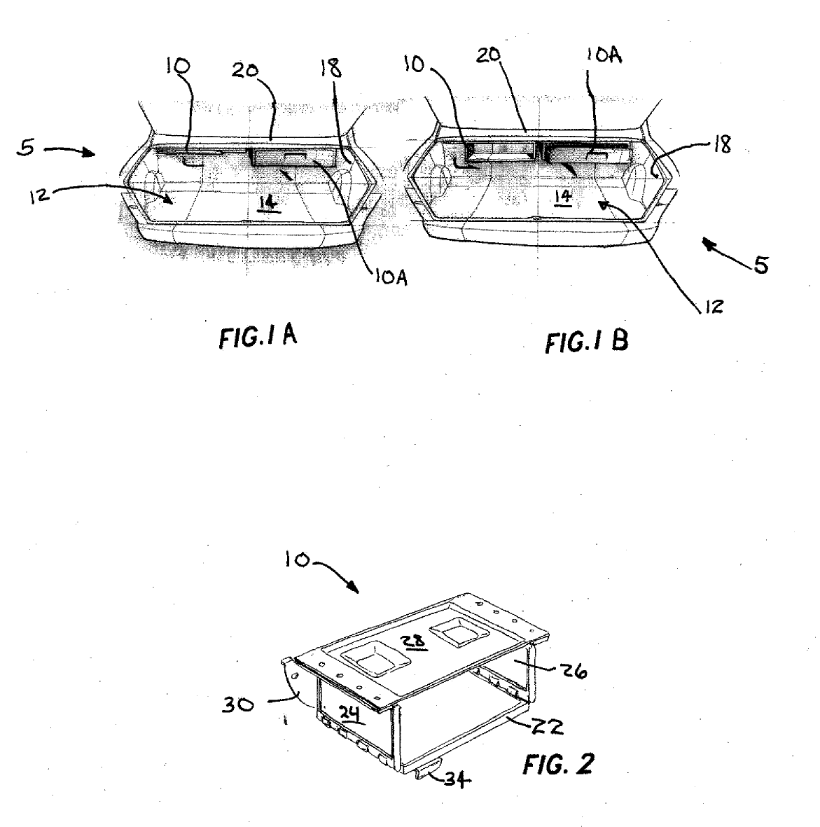

Referring to FIGS. 1A and 1B, an exemplary expandable/collapsible storage apparatus 10 for storing items within a vehicle compartment 12, according to embodiments of the present invention, is illustrated. The illustrated vehicle compartment 12 may comprise a trunk of an automobile 5. However, it is understood that embodiments of the present invention may be utilized in various compartments of various types of transportation vehicles, such as the rear storage area of a mini-van, truck, station wagon crossover vehicle and/or sport utility vehicle, without limitation, or in planes trains and ships. The illustrated vehicle compartment 12 includes a floor 14 having a floor covering (e.g., carpet, mat, etc.) and at least one side wall 18 extending substantially vertically from the floor 14. The illustrated vehicle compartment 12 is partially defined by the floor 14, the side wall 18 and an upper back panel 20. Other walls, seat backs, and package trays (not shown) may further define the vehicle compartment 12. The upper back panel 20 in a sedan vehicle may span the distance between the rear window and trunk lid of the vehicle, and may at least partially support the package tray. In extended vehicles, such as minivans and SUV's, since the rear cargo door may extend to the roof of the vehicle, the upper back panel may comprise the rear portion of the roof. The exemplary expandable/collapsible drop down storage apparatus may then be attached to the underside of the rear roof section of the vehicle. In other embodiments, it is contemplated that the exemplary apparatus may be attached to the underside of a shelf which may lie under the roof, or may even be attached to the side wall of the cargo space and extend substantially horizontally to provide organized storage space.

The expandable/collapsible storage apparatus 10 is shown in a collapsed or folded condition in FIG. 1A, latched against the underside of the upper back panel 20. On the right side of the vehicle trunk 12 in FIG. 1A, a second collapsible storage apparatus 10A is shown in expanded, or drop down position. The second apparatus 10A may include a drawer or front panel as shown. FIG. 1B illustrates the storage apparatus 10 in an expanded position ready to receive items for storage and the second apparatus 10A with the front panel ajar.

FIG. 2 is an enlarged view of an exemplary embodiment of the collapsible storage apparatus 10, according to the present invention. The apparatus 10 may comprise a bottom shelf 22, side wall panels 24, 26 and an optional top panel 28. In a preferred embodiment, the apparatus 10 may also include hinge brackets 30, 32 and a latch handle 34.

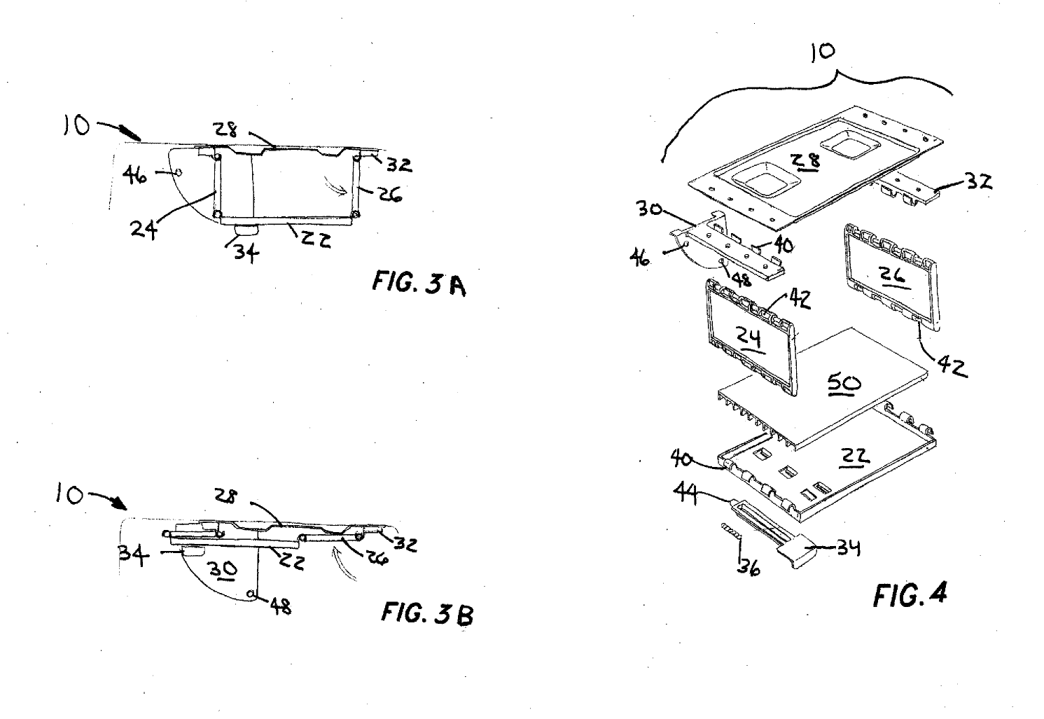

FIG. 3A illustrates the apparatus of FIG. 2 in front view in an expanded (dropdown) position to receive articles for storage. A spring-loaded latch handle 34 may lock the apparatus 10 in place providing rigidity, as will be described later. FIG. 3B illustrates the same apparatus 10 in a folded up or collapsed position against the inside of an upper panel or roof of a transportation vehicle. In this position, latch handle 34 has been retracted and a pin 44 on the end of the handle (see FIG. 4) has been retracted from hole 48 in bracket 30. A force may be applied laterally to the apparatus 10 to pivot the walls such that the pin 44 on the end of latch handle 34 may line up with hole 46. This may latch the apparatus 10 in a collapsed position where the apparatus will take up much less space and be out of the way for storage of other larger items in the storage compartment. In this collapsed position, one or more of the panels 22, 24, 26 and 28 may at least partially overlie another of the panels. It is further contemplated that any intermediate position between fully expanded (FIG. 3A) and fully collapsed (FIG. 3B) may be useful to provide a storage area and not substantially encroach on the remainder of the trunk or cargo space area. This may be accomplished by providing holes in locations between 46 and 48 in bracket 30 for pin 44 in handle 34 to engage.

FIG. 4 is an exploded view of the exemplary apparatus of FIG. 2 illustrating the various components in greater detail. The upper or cover panel 28 may lie beneath speakers in the package tray area of the vehicle and have complimentary depressions to receive the speaker housings. Optimally, there may be no upper panel and the lower surface of the package tray or other vehicle components may form the upper panel of the apparatus. Preferably, brackets 30 and 32 may be mechanically attached to the underside of the package tray or roof panel and may include a series of projections or bent tangs 40, which engage with openings 42 at the top of side panels 24 and 26 to provide pivoting action. Similarly, the bottom panel 22 may include projections or bent tangs 40 which engage like-shaped openings in the bottom of side panels 24, 26 to allow pivoting of the panels, one to the other. The latch handle may be slidably mounted to bottom panel 22 by flanges and a spring 36 may be biased to hold the pin 40 into hole 46 or 48. A stiffening panel 50 may also be included on bottom shelf 22.

While one exemplary embodiment of the expandable/collapsible or foldable cargo storage apparatus 10 has been described in FIGS. 1-4, other configurations are contemplated.

The panels of the apparatus may be corrugated and of polymeric composition with the pivots comprising a living hinge. The panels may also comprise sections of fiberboard or similar stock covered by a polymeric film or sheeting wherein the sheeting provides the hinging between panels.

The top panel of the apparatus may comprise the same material as the other panels, those panels capable of pivoting around the top panel. In another configuration, the top panel may comprise an undersurface of the vehicle compartment roof or even the package tray in the vehicle.

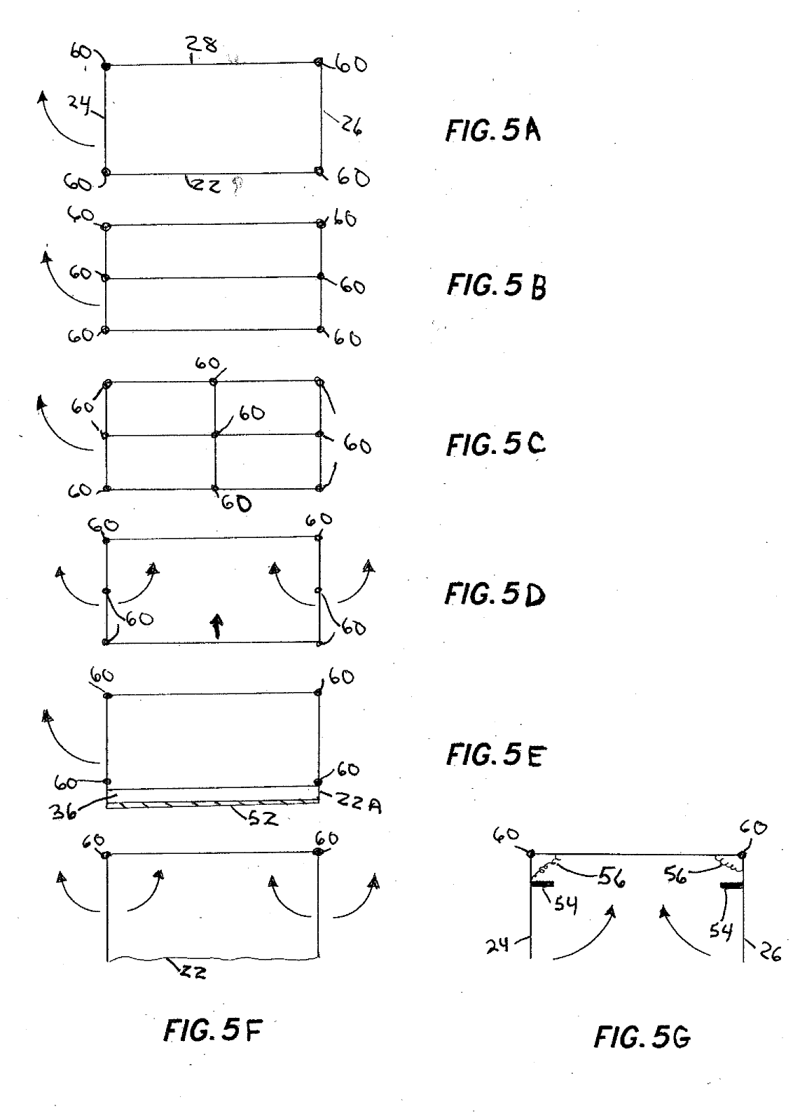

In another embodiment, it is contemplated that the bottom panel may be fabric or a flexible member (see FIG. 5A). In a still further embodiment it is contemplated that the side panels may be spring-loaded and include flanges such that in an expanded position, the side panels are vertical and a drawer with protruding edges may be slid between the side panels such that the flanges support the protruding edges (see FIG. 5G). When the drawer is removed, the side panels fold upward due to the bias of the springs.

As shown in FIGS. 1A and 1B, the storage apparatus may also include a front and/or back (not shown) close-out panel to totally enclose the storage space. In this configuration, the front and rear panels may be removable for separate storage when the apparatus is collapsed, or the front and rear panels may be connected by a hinge 52 to the bottom panel (see FIG. 5E). In that configuration, the lower panel may include an upstanding lip portion 22A which may allow the front and rear panels to fold inward and allow the side walls to lay flush upon these panels when the apparatus is collapsed.

Rather than include a front or rear panel to close out the storage space provided by the apparatus, a suitably sized drawer may be provided to slide into the storage space and contain a variety of smaller items.

In a related embodiment, the storage space formed by the drop down apparatus in an expanded condition may be sized to accept a piece of luggage, thus freeing up space on the floor of the compartment.

It is further contemplated that the storage apparatus of the present invention may be accessible from within the occupants' compartment of the vehicle without having to depart the vehicle or open the trunk. This may be accomplished by including doors or openings in the package shelf area of the vehicle and through top panel 28. It is also contemplated that access to the storage apparatus may be provided through or adjacent the rear seats of the vehicle, such as through a “pass-through” door, which is often located between the rear seats and accesses the trunk area. This may allow the storage apparatus to function as a waste container or storage area for toys.

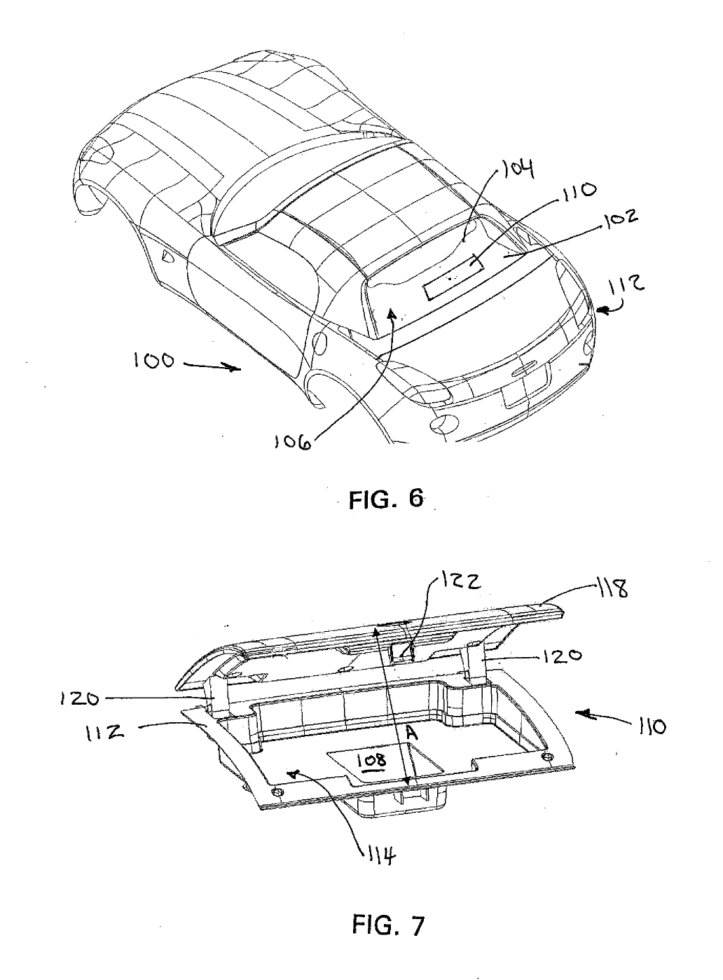

In that regard, an opening may be formed in the rear package shelf (or tray) of a vehicle and closed with a door. See FIG. 6. The door(s) may be positioned over one or more of the expandable/collapsible storage apparatus 10 such that access to the contents of the apparatus may be possible from within the passenger space of the vehicle, without having to depart the vehicle. Further, if a drawer is used for storage in such apparatus, the contents of the drawer may be accessible without having to remove the drawer. It is further contemplated that access to other areas of the vehicle trunk may also be possible through such an opening in the package tray.

FIGS. 1-4 illustrate one configuration of the apparatus of the present invention. In this configuration, the unfolding provides a single compartment which may be collapsed by applying a lateral force to one of the side walls after any latching or detent apparatus has been unlatched.

It is contemplated that other configurations are possible including, but not limited to, a plurality of rows and/or columns of storage spaces as shown in schematic view in FIGS. 5A-5C.

FIG. 5A is a schematic representation of the pivotable panels of the exemplary embodiment shown in FIG. 2. The pivot points are identified as reference numeral 60. Applying a lateral force to one of the side panels may cause the apparatus to fold to an essentially flat configuration beneath top panel 28. (See FIG. 3B.)

FIG. 5B is a schematic view of a similar apparatus having two storage compartments which again may be collapsed by a lateral force applied to either of the side panels.

FIG. 5C is a schematic view of an apparatus having four compartments and may be similarly collapsed.

FIG. 5D has pivot points 60 along each of the side walls such that they may both pivot inward so that no additional lateral space is required for storage and the apparatus may collapse vertically. Alternatively, the side walls may both pivot outwardly.

FIG. 5E illustrates the presence of a front 36 and/or rear panel hinged to bottom panel 22 along hinge 52. To provide for flat storage of the apparatus, side walls 22A on lower panel 22 may be extended upward such that when the front and/or rear panels are hinged inwardly (as shown), the adjacent side wall panels may lie flat upon the front and/or rear panels.

FIG. 5F illustrates an embodiment where the lower panel 22 may be a flexible material which may be pulled taut when an appropriately sized rectangular article is slid into the apparatus.

Finally, FIG. 5G illustrates a drop-down expandable/collapsible storage apparatus having no bottom panel. In this embodiment, the side panels 24, 26 may be spring-loaded and include inwardly projecting flanges 54. This configuration is suitable for storing a relatively rigid container (drawer, suitcase) that may be sized to slide in on top of the flanges 54 and hold the side panels in an extended position. For example, a suitcase that has a vertical height when stored of up to about 12 inches (i.e. a suitcase lying on its side). When the container is removed, springs 56 may retract the side panels to a collapsed position against the underside of the roof or vehicle closeout panel. Thus, any size and number of storage spaces may be possible.

In addition, it is contemplated that the folding or collapse of the apparatus may occur by applying a lateral force to a side panel or by having the side walls fold inwardly, accordion style, as illustrated schematically in FIG. 5D.

FIG. 6 is a schematic view of a vehicle 100 including a door 110 in the package shelf 102 for access to the storage apparatus 10 of the present invention. A package shelf 102 may be located between the back 104 of the rear seat and the rear window 106 of a vehicle 100 and located over a portion of the vehicle trunk 112 which may house the storage apparatus 10 of the present invention. See FIGS. 1A and 1B. The package shelf 102 may include a door 110 which may provide access by occupants of the passenger's compartment to the vehicle trunk 112 or to the storage apparatus 10 described herein without having to depart the vehicle or open the trunk 112.

FIG. 7 is a perspective view of an exemplary door 110 for accessing such storage areas. The door 110 may include a frame 112, a shallow storage bin 114 and a lid 118. Within the bin 114, there may be an opening 108, of sufficient size and location so as to provide access to articles stored in the trunk 112 or in storage apparatuses 10 located within the trunk. The lid may be hinged 120 and include a latch 122 and dampener means to control opening and closing. FIG. 7 illustrates the lid 118 in an open condition, note arrow A. While FIG. 7 illustrates a shallow bin 114, it is contemplated that the opening 108 may comprise some or all of the area within the frame 112, and that no bin may be present.

Further, it is contemplated that while shown in exemplary embodiments as a drop down storage apparatus from a substantially horizontal panel in a vehicle, the apparatus may be disposed from any surface which it may be attached to, for instance, pulled up from a floor panel or extended outward laterally from the side wall of a cargo space, all with the object of organizing storage and improving space utilization.

Thus, an expandable/collapsible apparatus is provided for organizing storage space and improving space utilization in a vehicle. The apparatus may be attached to an inside surface of a storage compartment. The apparatus may include a series of panels pivotally connected together and capable of folding flat and being latched in place in a first position, and upon unlatching, capable of pivoting and optionally dropping down into an expanded position to receive items for storage (a drawer, luggage, boxes, etc.).

Each of the storage apparatus embodiments described and illustrated herein may also be portable such that they can be easily placed within a vehicle compartment and removed therefrom. Although embodiments of the present invention have been described and illustrated with respect to installation within the trunk of an automobile, it is understood that apparatus, according to embodiments of the present invention, may be installed in various other compartments and areas of various types of vehicles.

The foregoing is illustrative of the present invention and is not to be construed as limiting thereof. Although a few exemplary embodiments of this invention have been described, those skilled in the art will readily appreciate that many modifications are possible in the exemplary embodiments without departing from any of the above described general teachings and advantages.

What is claimed is:

1. An expandable/collapsible storage apparatus comprising:
a plurality of panels pivotally attached to one another such that in a first expanded position the panels are in an adjacent spaced apart relationship to form one or more storage compartments and in a second collapsible position the panels articulate to at least partially overlie one another.

2. The apparatus of claim 1 wherein said apparatus is disposed adjacent the underside of a substantially horizontal panel in a vehicle.

3. The apparatus of claim 2 wherein said substantially horizontal panel comprises a rear package shelf.

4. The apparatus of claim 2 wherein said substantially horizontal panel comprises a vehicle rear deck.

5. The apparatus of claim 2 wherein said substantially horizontal panel comprises a vehicle roof portion.

6. The apparatus of claim 1 wherein said one or more storage compartments include a front and/or a rear door.

7. The apparatus of claim 1, wherein said one or more storage compartments include a slidable drawer.

8. The apparatus of claim 1 wherein said one or more storage compartments further includes a latch pin which is capable of engaging a hole in a bracket to fasten said apparatus in said second position.

9. The apparatus of claim 1 wherein said pivotal attachment comprises hinges.

10. The apparatus of claim 9 wherein said hinge is a living hinge.

11. The apparatus of claim 1 wherein said one or more storage compartments are accessible from within the passenger's compartment of said vehicle.

12. A rear package shelf for a vehicle which provides access to the trunk of said vehicle comprising a molded plastic panel which extends between the top of the seat back and an inner periphery of the rear window of said vehicle wherein said panel includes an opening, closed by a door, said opening providing access to one or more storage areas within said trunk by lifting said door.

13. The rear package shelf of claim 12 wherein said one or more storage areas comprise a collapsible/expandable storage apparatus attached to the underside of said shelf.

14. The rear package shelf of claim 12, wherein said one or more storage areas comprise the storage area of said trunk.

15. The rear package shelf of claim 12, wherein said door includes a dampening mechanism.

16. A rear package shelf for a vehicle which provides access to the trunk of said vehicle comprising a molded plastic panel which extends between the top of the seat back and an inner periphery of the rear window of said vehicle wherein said panel includes an opening, closed by a door, said opening providing access to a storage area within said trunk by lifting said door, wherein said storage area includes a plurality of panels pivotally attached to one another such that in a first expanded position the panels are in an adjacent spaced apart relationship to form one or more storage compartments and in a second collapsible position the panels articulate to at least partially overlie one another, wherein said apparatus is disposed adjacent the underside of said rear package shelf.

17. The rear package shelf of claim 16 wherein said one or more storage compartments includes a latch pin which is capable of engaging a hole in a bracket to fasten said apparatus in said second position.

18. The rear package shelf of claim 16 wherein said pivotal attachment comprises hinges.
